(19) United States
(12) Patent Application Publication
(10) Pub. No.: US 2005/0197421 A1
(43) Pub. Date: Sep. 8, 2005

(54) Process for preparation of cyanoacrylate compositions

(76) Inventor: Gary L. Loomis, Rancho Santa Fe, CA (US)

Correspondence Address: Gary L. Loomis, 990 Highland Drive, Suite Q, Solana Beach, CA, 92075, US

(21) Appl. No.: 10/793,123

(22) Filed: Mar. 3, 2004

(51) Int. Cl. C08G 2/00

(52) U.S. Cl. 522/178

(57) ABSTRACT

Processes for modifying the viscosity of medically useful cyanoacrylate compositions are described. The processes are carried out by providing to a fluid composition comprising a polymerizable monomer a controlled dose of high-energy radiation sufficient to effect a viscosity increase to a precise predetermined value. Compositions produced via these process are also disclosed.

### FIELD OF THE INVENTION

This invention relates generally to processes for the formation of polymerizable cyanoacrylate compositions useful in medical applications and to the compositions obtained from these processes.

### BACKGROUND OF RELATED ART

Compositions based on polymerizable alkyl cyanoacrylates useful for both industrial and medical applications are well-known in the art. Medical applications for alkyl cyanoacrylate compositions include uses in topical application as described in U.S. Pat. No. 5,306,490 and U.S. Pat. No. 5,403,591. Other suggested medical applications include a use for inhibiting irritation arising from prosthetic devices as described in U.S. patent application Ser. No. 08/200,953 as well as a use for inhibiting skin irritation and infection due to incontinence as described in U.S. patent application Ser. No. 08/299,935. The uses of alkyl cyanoacrylate compositions in the management of small wounds is described in U.S. Pat. No. 5,417,352. U.S. Pat. No. 6,538,026 and U.S. Pat. No. 6,476,070 describe cyanoacrylate compositions useful for filling an existing space in a mammalian body, e.g., the lumen of a blood vessel, the sac of a vascular aneurysm, a space created by a transiently placed external device, a space created by a surgical procedure, or a space created by a implantation of an object such as a stent or similar device. U.S. Pat. No. 6,335,384 describes methods for embolizing blood vessels utilizing biocompatible prepolymers including, cyanoacrylates, hydroxyethyl methacrylate, silicon prepolymers, and the like. While U.S. Pat. No. 6,476,069 provides a cyanoacrylate composition useful as an embolic agent that selectively creates a total or partial blockage in the lumen of a blood vessel, duct, fistula or other body passageway.

The preferred viscosity for alkyl cyanoacrylate compositions depends largely on the intended application of the specific composition. For example, relatively low viscosities are often preferred for adhesives where the application is to be made to a large surface area. Contrarily, where the application of a cyanoacrylate adhesive composition is to be made to a specific location on the skin, higher viscosity materials are preferred to prevent running of the material to unintended locations.

A variety of viscosity modifiers have been described for use with various 2-cyanoacrylate compositions. For example, U.S. Pat. No. 3,527,841 to Wicker et al. discloses 2-cyanoacrylate adhesive compositions for both general and surgical uses containing a poly(lactic acid) viscosity modifier that is soluble, after heating, in a wide range of 2-cyanoacrylates. After addition of the poly(lactic acid), the composition is sterilized at temperatures up to 150° C. and the resulting compositions undergo a decrease in viscosity, presumably due to degradation of the thickener during the thermal sterilization process.

U.S. Pat. No. 5,665,817 to Greff et al. discloses alkyl cyanoacrylate compositions suitable for topical application to human skin. These compositions may comprise a suitable amount of a thickening agent to provide a compositional viscosity of from about 2 to 50,000 cps at 20° C. The thickening agents employed include a partial polymer of the alkyl cyanoacrylate, poly methylmethacrylate (PMMA), or other preformed polymers soluble in the alkyl cyanoacrylate composition.

U.S. Pat. No. 3,722,599 discloses compositions that combine a polymerization inhibitor, a thickener, and a plasticizer with a fluoroalkyl cyanoacrylate for use as suture replacements or as hemostats.

U.S. Pat. No. 6,538,026, U.S. Pat. No. 6,476,069 and U.S. Pat. No. 6,476,070 disclose cyanoacrylate compositions that employ low levels of purified polymers of alkyl cyanoacrylates as viscosity modifying agents.

U.S. Pat. No. 4,038,345 to O'Sullivan, et al. describes a process for producing enhanced viscosity 2-cyanoacrylate adhesives by the addition of thickening agents. The thickeners used in these compositions are thermally treated polyacrylate polymers and the process involves heating the polyacrylate thickener to a temperature between 140°-180° C. for 30 to 180 minutes and subsequently dissolving the heat-treated thickener in the 2-cyanoacrylate composition.

A thickened allyl cynoacrylate dental adhesive composition is described in U.S. Pat. No. 4,136,138 to Dombroski, et al. The thickener is added to impart desired flow properties of the composition on the tooth and to reduce the polymerization shrinkage. The thickeners are present in quantities from 3 to 15 parts by weight and the preferred thickeners are those selected from a variety of polymers, copolymers, and terpolymers selected from such groups as polyesters, polyolefins, and polyvinyls having thickening characteristics suitable for this application. Specific examples of these thickeners are poly(methyl methacrylate), poly(methyl acrylate-co-acrylonitrile) (60/40 weight percent), poly(ethylacrylate), poly(butyl acrylate), and poly(ethyl acrylate-co-butyl acrylate).

U.S. Pat. No. 6,386,203 to Hammerslag describes alkyl cyanoacrylate compositions with controlled viscosity achieved by the use of fumed silica as a thickening agent. However, disadvantages arise from the difficulty of producing an even dispersion of the particulate silica in the composition and in the maintenance of such a dispersion. In fact, a practical disadvantage of most known techniques for producing viscosity modified cyanoacrylate compositions for medical applications is the requirement that the thickening agent be accurately metered and then dissolved or dispersed into the cyanoacrylate, since such processes are likely to introduce contamination.

It is know that many vinyl monomers can be induced to polymerize under the influence of high energy radiation and there are cyanoacrylate compositions specifically formulated to polymerize upon exposure to UV light and such compositions are described in U.S. Pat. No. 6,433,036.

U.S. Pat. No. 3,527,224 to Rabinowitz describes adhesive compositions comprising monomeric and polymeric n-pentyl cyanoacrylates prepared by subjecting the composition to a lengthy exposure to a UV light source. Such lengthy exposures are likely to effect undesirable side reactions such as crosslinking and decomposition. By contrast, in C. Kutal, P. A. Grutsch and D. B. Yang, “A Novel Strategy for Photoinitiated Anionic Polymerization”, Macromolecules, 24, 6872-73 (1991), the authors state that ethyl cyanoacrylate is “unaffected by prolonged (24-h) irradiation with light of wavelength >350 nm”. Such disparities demonstrate the need for controlled processes.

Therefore, a need exists for the production of viscosity-enhanced alkyl cyanoacrylates compositions in a fast, reproducible process that eliminates or minimizes side reactions. Move specifically, a need exists for processes for the production of medically useful cyanoacrylate compositions with controlled viscosity. Such processes should negate the need for the addition of viscosity modifying additives. Furthermore, a need exists for improved cost-efficient cyanoacrylate processes for the production of such compositions. Finally, a need exists for a simple process to simultaneously thicken and sterilize such compositions for medical applications without affecting performance of the composition. The present invention is directed to meeting these and other needs.

### SUMMARY OF THE INVENTION

The present invention meets the desires expressed above by providing simple, well-controlled processes to produce viscosity enhanced compositions which include a polymerizable cyanoacrylate monomer component. Desirably, the compositions produced by processes of the present invention retain the benefits and advantages of viscosity enhanced cyanoacrylate compositions produced by other processes known in the art. An important aspect of the of the present invention is to provide processes that reduce or eliminates undesired or uncontrolled side reactions by employing process times significantly shorter than those of the processes described in the art.

In one embodiment of the present invention, there is provided a method of enhancing the viscosity of a medically useful cyanoacrylate composition by providing to a quantity of the composition a precisely controlled radiation dose sufficient to effect a viscosity increase to a precise predetermined value.

In another embodiment of the present invention, there is provided a method of enhancing the viscosity of a medically useful cyanoacrylate composition by exposing to an ultraviolet radiation source an initial cyanoacrylate composition containing a photsensitizer, wherein the photsensitizer has an absorbance maximum at or near the emission maximum of the ultraviolet radiation source.

In another embodiment of the present invention, there is provided a method of simultaneously thickening and sterilizing medically useful cyanoacrylate compositions by providing an amount of the cyanoacrylate composition to a precise radiation dose sufficient to simultaneously effect the desired viscosity increase and the requisite sterility.

In another embodiment of the present invention, there is provided a process in which a completely formulated and packaged cyanoacrylate composition is simultaneously viscosity modified and terminally sterilized in a single-step by exposing said packaged cyanoacrylate composition to a precise dose of high energy radiation such as ultraviolet light under carefully controlled conditions of temperature and environment.

The present invention will be more readily appreciated by those persons of skill in the art based on a reading of the detailed description of the invention which follows and the examples presented thereafter for illustrative purposes.

### DETAILED DESCRIPTION OF THE INVENTION

The present invention provides processes for enhancing the viscosity of fluid compositions comprising at least one polymerizable monomer by subjecting the fluid compositions to a radiation dose sufficient to effect a viscosity increase to a precise predetermined value. Such compositions are useful for medical applications as well as other applications. In certain medical applicatiopns that require that the composition be delivered through a microcatheter, it is desirable that the compositions exhibit shear thinning rheological behavior. Such rheological behavior is also referred to as pseudoplastic behavior. In an ideal fluid, usually referred to as a Newtonian fluid, the viscosity is independent of the shear rate. However for a shear thinning fluid at lower shear rates the shear thinning fluid is more viscous than the Newtonian fluid and at higher shear rates it is less viscous.

Polymerizable monomers useful in embodiments of the processes and compositions obtained by the processes of the present invention include 1,1-disubstituted ethylene monomers of the formula (I):
RHC═CXY (I)
wherein X and Y are each strongly electron withdrawing groups, and R is H, —CH═CH2; or, a C₁ to C₄ alkyl group, provided that X and Y are each cyano groups.

Examples of polymerizable monomers within the scope of formula (I) include 2-cyanoacrylates, vinylidene cyanides, C1-C4 alkyl homologues of vinylidene cyanides, dialkyl methylene malonates, acylacrylonitriles, vinyl sulfinates and vinyl sulfonates of the formula (II):
CH2=CX′Y′ (II)
wherein X′ is —SO₂R′ or —SO₃R′ and Y′ is —CN, —COOR′, —COCH₃, —SO₂R′ or —SO₃R′, and R′ is H or hydrocarbyl.

Examples of specific polymerizable monomers of formula (I) for use in the present invention are 2-cyanoacrylates of formula (III): 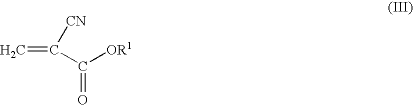
wherein R¹ is a straight-chain hydrocarbyl, a branched-chain hydrocarbyl, a cyclohydrocarbyl, a halohydrocarbyl moiety, or a substituted hydrocarbyl moiety; a group having the formula —R²—O—R³—O—R⁴ wherein R² is a 1,2-alkylene group having 2 to 10 carbon atoms, R³ is an alkylene group having 2 to 10 carbon atoms, and R⁴ is an alkyl group having 1 to 10 carbon atoms; or a group having the following formula: 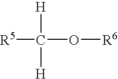
wherein R⁵ is 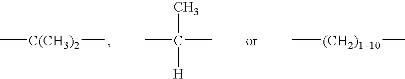
and wherein R⁶ is an organic moiety.

Specific examples of polymerizable monomers useful in the process and compositions of the present invention are alkyl 2-cyanoacrylates including ethyl 2-cyanoacrylate; n-butyl cyanoacrylate; iso-butyl 2-cyanoacrylate; n-hexyl cyanoacrylate; 2-hexyl 2-cyanoacrylate; n-octyl 2-cyanoacrylate; 2-octyl-2-cyanoacrylate; 2-ethylhexyl 2-cyanoacrylate; 3-methoxybutyl 2-cyanoacrylate; 2-butoxyethyl cyanoacrylate; 2-isopropoxyethyl 2-cyanoacrylate; and 1-methoxy-2-propyl 2-cyanoacrylate. Most preferred 2-cyanoacrylates useful in the compositions and processes of the present invention are n-butyl-2-cyanoacrylate; 2-hexyl-2-cyanoacrylate, 2-ethylhexyl 2-cyanoacrylate and 2-octyl-2-cyanoacrylate.

Also useful in certain embodiments of the present invention are polymerizable 2-cyanoacrylates monomers of formula (III) wherein R¹ is a poly(alkylene) oxide. Such poly(alkylene) oxides can include, for example, poly(ethylene) oxide, poly(propylene) oxide, poly(butylene oxide), and mixtures and copolymers thereof.

The 2-cyanoacrylates of formula (III) can be prepared according to methods known in the art. For example, U.S. Pat. Nos.3,591,676; 3,667,472; 3,995,641; 4,035,334; and 4,650,826 the disclosures of which are each incorporated herein by reference in their entirety.

For example, the 2-cyanoacrylates can be prepared by reacting an alkyl cyanoacetate with formaldehyde in a non-aqueous organic solvent and in the presence of a basic catalyst, followed by pyrolysis of the obtained intermediate polymer in the presence of a polymerization inhibitor. The 2-cyanoacrylates monomers prepared with low moisture content and essentially free of impurities are preferred for biomedical use.

Also useful in the present invention are polymerizable 2-cyanoacrylates of formula (III) wherein R¹ is a group having the following formula: 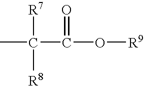
wherein R⁷and R8 are hydrogen or methyl and R⁹ is an organic radical. The preparation of such cyanoacrylates are described in U.S. Pat. No. 3,995,641 the disclosures of which is incorporated herein by reference in its entirety.

Other polymerizable monomers useful in certain embodiments of the invention are 3-(acryloyloxy)sulfolanes and 3-(methacryloyloxy)sulfolanes of formula (IV): 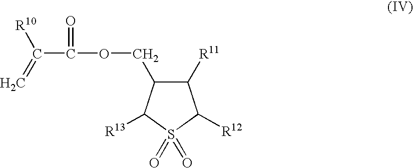
wherein R¹⁰ is H or CH₃; and wherein R¹¹, R¹², R¹³ are either H or organic moieties

Still other polymerizable monomers useful other embodiments of the present invention are 3-(acryloyloxy)sulfolanes of the formula (V) 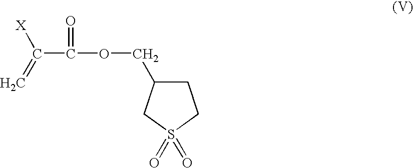
wherein X is —CN, —Cl, —Br, —I, —COCH₃, —COOR′ and R′ is H or hydrocarbyl.

In certain embodiments of the present invention the initial fluid composition is rendered essentially oxygen-free. Removal of dissolved oxygen from the initial fluid composition may be accomplished in various ways known to those skilled in the art. A common method to remove dissolved oxygen is by sparging the fluid composition with an inert gas such as nitrogen or argon. In another common method dissolved oxygen is removed by subjecting the fluid composition to repetitive freeze-pump-thaw cycles. Utilizing either method allows the reaction to be carried out in oxygen-free environment thereby ensuring an element of process control. In a particularly useful embodiment the initial fluid composition is rendered essentially oxygen-free and the process is thereafter carried out in a closed system with an atmosphere of inert gas such as nitrogen or argon maintained throughout the process.

The term high-energy radiation as used in the present invention is to be construed broadly to include any form of radiation conventionally used to initiate chemical reactions. Such radiation-induced chemical reactions include free-radical reactions, ion-radical reactions, anionic reactions, cationic reactions and concerted photochemical reactions. Non-limiting examples of such high-energy radiation include ultraviolet (UVA, 320-400 nm; UVB, 290-320 nm; and UVC, 220-290 nm); electron-beam radiation; gamma-radiation; and x-ray.

Ultraviolet radiation can be provided by any appropriate source able to generate the desired radiation, such as high pressure, medium pressure or low pressure mercury arc lamps; longwave UV lamps; He—Ne lasers; argon ion lasers; and diode pumped crystal lasers such as Nd:YAG, Nd:YVO4 or Nd:YLF.

In another embodiment the radiation source provides ultraviolet light in the range of 200 nm-600 nm. Preferably in the range 220 nm-400 nm and more preferably in the range 220 nm-300 nm. Convenient sources of suitable ultraviolet radiation are commercially available 100 to 1200 watt medium pressure, quartz, mercury-vapor lamps such as those obtainable from Hanovia Corporation, Union, N.J. Ranges of wavelength output from wide-band sources such as mercury vapor lamps may be conveniently controlled by the use of filters placed between the source and the compositions to be irradiated.

The most common sources of gamma-radiation are ⁶⁰Co and ¹³⁷Cs. Electron-beam irradiation involves the use of high energy electrons generated by an RF linear accelerator. Electron-beam irradiation with energies typically ranging from 3 to 10 MeV and power ranging from 1 to 50 kW is readily available.

Certain embodiments of the present invention present processes for enhancing the viscosity of polymerizable compositions wherein the initial fluid compositions further comprise one or more photosensitizers. The terms photosensitizer, photoinitiator, and photoactivator are often used interchangeably in the art, therefore, in the context of the present invention the term photosensitizer is to be understood to encompass materials described elsewhere as photoinitiators or photoactivators. As components of the compositions described in the present invention, photosensitizers are compounds that convert absorbed radiation into chemical energy in the form of initiating species that enhances the rates of the reactions which occur when the compositions as a whole are exposed to electromagnetic radiation such as ultraviolet light.

Photosensitizers useful in the present invention may be exemplified by benzoyl compounds; coumarin compounds; phenyl ketones such as acetophenone, benzophenone and appropriately substituted derivatives thereof; alkyl pyruvates, such as methyl, ethyl, propyl, and butyl pyruvates and appropriately substituted derivatives thereof; aryl pyruvates, such as phenyl and benzyl pyruvates and appropriately substituted derivatives thereof; benzoin ether compounds such as isobutylbenzoin ether and appropriately substituted derivatives thereof; ketal compounds such as acetophenone diethyl ketal and appropriately substituted derivatives thereof; aryl phosphine oxides and appropriately substituted derivatives thereof; and thioxanthone compounds.

Examples of photosensitizers particularly useful in the present invention include, but are not limited to, 1-hydroxycyclohexyl phenyl ketone; 1-(4-isopropylphenyl)-2-hydroxy-2-methylpropan-1-one; 2-hydroxy-2-methyl-1-phenyl-propan-1-one; 2,2-dimethoxy-2-phenyl acetophenone; 2-methyl-1-[4-(methylthio)phenyl]-2-morpholino propan-1-one; 2-benzyl-2-N,N-dimethylamino-1-(4-morpholinophenyl)-1-butanone; 2-benzyl-2-(dimethylamino)-4′-morpholinobutyrobenzophenone; 2,4,6-trimethyl-benzoyldiphenylphosphine oxide; bisacylphosphine oxide; bis-(2,6-dimethoxybenzoyl)-2,4,4-trimethylpentylphosphine oxide; bis(2,4,6-trimethyl benzoyl)phenyl phosphine oxide. Any of these may be used singly or in combination of two or more.

In another embodiment of the present invention the initial fluid composition contains a photosensitizer that is chemically bound to a non-reactive, insoluble polymer. Such a polymer-bound photosensitizerr is conveniently provided in the form of particles such as insoluble beads which may be conveniently removed from the reaction medium via simple processes such as filtration, centrifugation and the like.

An important aspect of embodiments of the present invention is the provision of shortened process time in order to reduce or eliminate undesired or uncontrolled side reactions and to allow for a minimum quantity of photosensitizer compound to be used.

In another embodiment of the present invention the photosensitizer is chosen such that the wavelengths at or near the absorption maximum of the photosensitizer are matched to the wavelenghts at or near the emmision maximum of the ultraviolet radiation. That is, the photosensitizer is chosen such that the strong absorption bands of the photosensitizer are matched to the emmision spectrum of the radiation source. By way of example, a medium pressure mercury arc lamp has strong UV emmisions between 310-320 nm while the photsensitizer 2-benzyl-2-(dimethylamino)-4′-morpholinobutyro-benzophenone has strong UV absorption between 300 and 340 nm. Therefore, where a medium pressure mercury arc lamp is used as the source of radiation 2-benzyl-2-(dimethylamino)-4′-morpholinobutyrobenzophenone is added to the composition as a photosensitizer. Other such combinations of photosensitizers and radiation sources will be apparent to those skilled in the art.

In other embodiments the initial solution presented is substantially free of free-radical inhibitors. Such inhibitors, which are often present in commerical polymerizable vinyl monomers such as alkyl cyanoacrylates, are conveniently reduced in concentration or are removed completely by treating the polymerizabe vinyl monomer with a selective adsorbent. Such selective adsorbents for free-radical inhibitor removal are readily available from Sigma-Aldrich, Inc., St. Louis, Mo.

Another embodiment of the process further comprises the step of adding one or more stabilizers to the resulting fluid composition. Such stabilizers may be anionic stabilizers or free-radical stabilizers. Examples of useful anionic stabilizers include but are not limited to mineral acids such as phosphoric acids and sulfonic acids, organic acids such as acetic acid, citric acid, and lewis acids such as sulfur dioxide and nitrogen oxides. Examples of useful free-radical stabilizers include but are not limited to hydroquinone, hydroquinone monomethyl ether, catechol, pyrogallol, bisphenol-A, bisphenol-S, 2,6-di-tert-butylphenol, 2,6-di-tert-butylcresol, 2,2′-methylene-bis(4-methyl-6-tert-butylphenol), 4,4′-butylidene-bis(3-methyl-6-tert-butylphenol), 4,4′-thiobis(3-methyl-6-tert-butylphenol), 2-hydroxybenzophenone, phenylsalicylic acid, 1,3,5-trimethyl-2,4,6-tris(3,5-di-tert-butyl-4-hydroxybenzyl) benzene, buytlated hydroxytoluene, butylated hydroxanisole and the like. The free-radical stabilizer can also be selected from among known antioxidants, including, but not limited to, vitamin E (including alpha-tocopherol, beta-tocopherol, gamma-tocopherol, delta-tocopherol, vitamin K (including but not limited to vitamin K₁ chromanol and vitamin K₁ chromenol), phylloquinone, menaquinone, menadione, vitamin C, pentamethyl chromanol, non-phenolic antioxidants, octyl gallate, pentamethyl benzofuranol and derivitives thereof.

In other embodiments the initial fluid composition may also include one or more agents known to produce free-radicals when suitably irradiated. Such agents are widely known as free-radical initiators or free-radical catalysts and can include, by way of example, azo compounds and organic peroxides. Suitable azo compounds include but are not limited to 2,2′-azobis(2-methylpropionitrile), 1,1′-azobis(cyclohexanecarbonitrile) and 2,2′-azobis(2-methylbutyronitrile). Suitable organic peroxides include but are not limited to benzoyl peroxide; cumene hydroperoxide; di-tert-amyl peroxide; dicumyl peroxide; lauroyl peroxide; tert-amyl peroxybenzoate; tert-amylperoxy 2-ethylhexyl carbonate; tert-butyl peracetate; tert-butyl perbenzoate; 1,1-bis(tert-butylperoxy)cyclohexane; 1,1-bis(tert-amylperoxy)cyclohexane; 2,5-bis(tert-butylperoxy)-2,5-dimethylhexane; 1,1-bis(tert-butylperoxy)-3,3,5-trimethylcyclohexane; 2,4-pentanedione peroxide; bis(tert-butylperoxyisopropyl)benzene; ethyl 3,3-bis(tert-amylperoxy)butyrate; tert-butylperoxy 2-ethylhexyl carbonate and tert-butylperoxy isopropyl carbonate.

In other embodiments of the present invention the initial fluid compositions further comprise one or more plastcizers. The term plasticizer in the context of the present invention is to be construed as any material which is soluble or dispersible in a polymerizable composition, and which increases the flexibility of the polymer obtained from polymerization of said polymerizable composition. Such plasticizers should be biocompatible to the extent required for the intended application. For example, a plasticizer used in a coating on the skin surface should be compatible with the skin as measured by the lack of skin irritation and a plasticizer used for an implant in the body should be non-toxic or of a toxicity sufficiently low as to be tolerated by the body. Suitable plasticizers are well known in the art and include those disclosed in U.S. Pat. Nos. 2,784,127 and 4,444,933 the disclosures of both of which are incorporated herein by reference in their entirety.

A list of plasticizers useful in the present invention includes, but is not limited to, fatty acid esters, citrate esters, phthalate esters, benzoate esters, and certain aromatic phosphate esters. By way of example, such useful plasticizers include butyl benzyl phthalate, dibutyl phthalate, diethyl phthalate, dimethyl phthalate, dioctyl phthalate, 2-ethylhexyl phthalate, benzoate esters of di- and poly-hydroxy branched aliphatic compounds, tri(p-cresyl) phosphate, alkyl myristates and the like. Plasticizers particularly useful in this invention are acetyltriethyl citrate, acetyl tri-n-butyl citrate, acetyl tri-n-hexyl citrate, n-butyryl tri-n-hexyl citrate, and ethyl myristate.

An accelerator, which may be optionally included in certain embodiments of the present invention, is a molecule containing a reactive carbon-carbon double bond such an allyl, vinyl, or acrylate group, that is capable of increasing the rate of a photochemical or free radical reaction. Suitable accelerators include, but are not limited to, N-vinyl pyrrolidinone, 2-vinyl pyridine, 1-vinyl imidazole, 9-vinyl carbazone, acrylic acid, and 2-allyl-2-methyl-1,3-cyclopentane dione.

The compositions of the present invention may additionally contain one or more radiopaque contrast agents so that a practitioner can visualize delivery of the liquid composition to the desired site via x-ray techniques such as fluoroscopy. Visualization is particularly necessary when using catheter delivery techniques in order to ensure both that the composition is being delivered to the intended vascular site and that the requisite amount of composition is delivered. Additionally, the use of contrast agents is beneficial during post-treatment procedures to visualize the embolized mass during, for example, surgery or to monitor the disease condition for re-treatment purposes.

Particularly useful in the present invention are insoluble contrast agents in particulate form. Examples of such insoluble, particulate contrast agents include but are not limited to tantalum, tantalum oxide and barium sulfate as well as nobel metals such as gold, palladium and platinum as well as mixtures and alloys thereof. Insoluble metal-cation salts of anionic polymer such as those described in U.S. Pat. No. 5,702,682 are also useful in certain embodiments of the present invention.

In another embodiment the temperature of the reaction medium is carefully controlled throughout the course of the process. This temperature control is conveniently achieved by use of a water-jacketed photochemical reaction vessel through which is circulated a thermostatically controlled fluid. A suitable photochemical apparatus to effect such temperature control is commercially available from Ace Glass Inc., Vineland, N.J.

Yet another embodiment provides a continuous process by the use of a thin film photochemical reactor such as the apparatus commercially available from Ace Glass Inc., Vineland, N.J.

The following examples are presented to illustrate embodiments of the invention, and shall not be viewed as limiting the scope of the invention.

### EXAMPLES

The examples shown below utilize a commercial photochemical reactor assembly (available as Catalog Number 7862-245 from Ace Glass Company, Vinland, N.J.) consisting of a 250 ml cylindrical, 3-neck, flat-bottomed, water-jacketed reaction vessel; a circulating water chiller; a quartz immersion well into which is inserted a 450 watt medium pressure, quartz, mercury-vapor lamp; a fluoropolymer-coated magnetic stir bar and a magnetic stirrer.

### Example 1

To the reaction vessel is introduced 50.0 ml butyl cyanoacrylate, rendered substantially free of free-radical stabilizers by passing through a 10″×¾″ column of absorbent (Aldrich Chem Co.). The reaction vessel content is degassed via three freeze-pump-thaw cycles after which the vessel is maintained under an argon atmosphere. The circulating water temperature is set and maintained at 20° C., stirring is commenced and the UV lamp is ignited. After 10.0 min. the UV lamp is extinguished and 100 ppm 4-methoxy phenol, 100 ppm hydroquinone and 25 ppm sulfur dioxide are immediately introduced into the reaction mixture. Viscosities of the initial and final compositions are measured at 20° C. with a Brookfield cone and plate viscometer. Initial viscosity=4.0 cps and final viscosity=35.5 cps

### Example 2

To the reaction vessel is introduced 95.0 ml 2-octyl cyanoacrylate and 5.0 ml n-butyl acrylate, rendered substantially free of free-radical stabilizers by passing through a 10″×¾″ column of absorbent (Aldrich Chemical Co.). The reaction vessel content is degassed via three freeze-pump-thaw cycles after which the vessel is maintained under an argon atmosphere. The circulating water temperature is set and maintained at 10° C., stirring is commenced and the UV lamp is ignited. After 10.0 min the UV lamp is extinguished and 100 ppm 4-methoxy phenol, 100 ppm hydroquinone and 25 ppm sulfur dioxide are immedialty introduced into the reaction mixture. Viscosities of the initial and final compositions are measured at 20° C. with a Brookfield cone and plate viscometer. Initial viscosity=4.5 cps and final viscosity=56.0 cps.

### Example 3

The data presented in table I demonstrate the shear thinning behavior of compositions comprising 2-hexyl cyanoacrylate prepared by the process of examples 1 and 2 above. In the present example a Brookfield LVCP (cone and plate) viscometer equipped with a No. 40 spindle is used. Since for a given composition, an increase in spindle speed relates to an increase in in shear rate, these data readily demonstrate that for each of the compositions A, B, and C apparent viscosity is reduced as shear rate (spindle speed) is increased.

TABLE I

| | Spindle | Apparent |
|---|---|---|
| Composition | Speed (rpm) | Viscosity (25° C.) |
| A | 1.00 | 41 |
| | 7.00 | 39 |
| B | 0.75 | 70 |
| | 4.50 | 39 |
| C | 0.30 | 157 |
| | 2.00 | 141 |

1. A process comprising the steps of:
i. providing a substantially oxygen-free initial fluid composition comprising at least one alkyl 2-cyanoacrylate monomer, and
ii. subjecting said initial fluid composition to a dose of high-energy radiation sufficient to afford a resulting fluid composition with a viscosity higher than that of said initial fluid composition.

2. The process of claim 1 wherein said initial fluid composition is free of stabilizers.

3. The process of claim 1 wherein said high-energy radiation is ultraviolet radiation.

4. The process of claim 2 wherein said ultraviolet radiation has a wavelength between 220 nm and 600 nm.

5. The process of claim 3 wherein said initial fluid composition further comprises photosensitizer.

6. The process of claim 5 wherein said photosensitizer is chosen such that the wavelengths at absorption maximum of said photosensitizer are matched to the wavelengths at the emission maximum of said ultraviolet radiation.

7. The process of claim 1 further comprising the step of adding a stabilizer to said resulting fluid composition.

8. The process of claim 7 wherein said stabilizer is a free-radical stabilizer.

9. The process of claim 7 wherein said stabilizer is an anionic stabilizer.

10. The process of claim 1 wherein said initial fluid composition further comprises a free-radical initiator.

11. The process of claim 10 wherein said free-radical initiator is an azo compound.

12. The process of claim 10 wherein said free-radical initiator is an organic peroxide.

13. The process of claim 1 wherein said initial fluid composition further comprises a plasticizer.

14. The process of claim 1 wherein said initial fluid composition further comprises a radiopaque contrast agent.

15. The process of claim 14 wherein said radiopaque contrast agent is an insoluble contrast agent in particulate form.

16. The process of claim 1 wherein said resulting fluid composition exhibits shear thinning rheology.

17. The composition obtained by the process of claim 1.
